(19) United States
(12) Patent Application Publication
(10) Pub. No.: US 2022/0092438 A1
(43) Pub. Date: Mar. 24, 2022

(54) METADATA-ASSISTED INVENTORY MANAGEMENT

(71) Applicant: CenturyLink Intellectual Property LLC, Broomfield, CO (US)

(72) Inventors: Steven M. Casey, Littleton, CO (US); Ron Lewis, Montgomery, AL (US); Christian Mays, Fate, TX (US); Stephen Opferman, Denver, CO (US)

(73) Assignee: CenturyLink Intellectual Property LLC, Broomfield, CO (US)

(21) Appl. No.: 17/475,475

(22) Filed: Sep. 15, 2021

Related U.S. Application Data
(60) Provisional application No. 63/082,653, filed on Sep. 24, 2020.

(51) Int. Cl. G06N 5/00; G06N 20/00; G06F 16/58; G06T 7/00

(52) U.S. Cl. CPC G06N 5/003; G06T 7/0004; G06F 16/5866; G06N 20/00

(57) ABSTRACT

Examples of the present disclosure relate to metadata-assisted inventory management. Image data relating to a device is captured and further enriched with metadata, such as customer information, current event data, and/or log data associated with the device. The enriched image data may be processed by a decision engine to generate determinations based on the image data in combination with the metadata. For example, an equipment classification decision engine generates an equipment classification for telecommunications equipment therein. As another example, a cost modeling decision engine processes the enriched image data to evaluate a cost associated with the telecommunications equipment or a service evaluation decision engine may process the enriched image data to determine whether telecommunications equipment and/or an associated service are performing as expected. A decision engine may update the enriched image data according to its processing, thereby further enriching the image data for processing by another decision engine.

### CROSS-REFERENCE TO RELATED APPLICATIONS

This application claims the benefit of U.S. Provisional Application Ser. No. 63/082,653 filed 24 Sep. 2020, entitled “Metadata-Assisted Inventory Management,” which is incorporated herein by reference in its entirety.

### BACKGROUND

Performing reliable computer-based optical identification of telecommunications equipment based solely on image data may be dependent on a variety of factors. For example, the quality of a machine learning model or the clarity of the image data may affect processing accuracy, among other factors.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure relate to metadata-assisted inventory management. In examples, images, videos, or other image data relating to a device are captured. The image data is further enriched with metadata relating to the image data, such as customer information, current event data, and/or log data associated with the device. The enriched image data may be processed by one or more decision engines to generate determinations based on the image data in combination with the metadata. For example, an equipment classification decision engine processes the enriched image data to generate one or more equipment classifications for telecommunications equipment therein.

As another example, a cost modeling decision engine processes the enriched image data to evaluate a cost associated with the telecommunications equipment or a service evaluation decision engine may process the enriched image data to determine whether telecommunications equipment and/or an associated service are performing as expected. A decision engine may update the enriched image data according to its processing, thereby further enriching the image data for processing by another decision engine. An event correlation engine may also process a determination generated by a decision engine to gather corroborating evidence, thereby providing insight into telecommunications equipment and associated services that may not otherwise be available using other network monitoring techniques.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for metadata-assisted inventory management.

FIG. 2 illustrates an overview of an example method for enriching image data from a client device using metadata.

FIG. 3A illustrates an overview of an example method for processing telecommunications equipment associated with enriched image data.

FIG. 3B illustrates an overview of an example method for performing cost modeling based on enriched image data.

FIG. 3C illustrates an overview of an example method for service evaluation based on enriched image data.

FIG. 3D illustrates an overview of an example method for correlating network events associated with a failure determination.

FIG. 4 illustrates an example of a suitable operating environment in which one or more of the present embodiments may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A challenge in telecommunications is maintaining an accurate inventory of telecommunications equipment that is used by a service provider to provide one or more services to a customer, which may be located at the physical premises of the customer (e.g., in an enterprise context, in a consumer context, etc.). For example, such equipment may not be inventoried in a database of the service provider or it may be incorrectly inventoried. As another example, there may be no inventory record of the equipment at the customer premises or an inventory maintained by the service provider may have a record for the equipment, but it may be incorrect (e.g., it may have an incorrect location, make, model, status, and/or configuration, etc.). Further, it is difficult to update the inventory, as the customer may not be knowledgeable about telecommunications equipment or may have equipment from a variety of service providers or equipment manufacturers. The lack of inventory correctness presents a significant challenge to serving customer needs (e.g., providing technical support, maintaining or replacing telecommunications equipment, etc.), evaluating adherence to service-level agreements (SLAs), and/or performing cost modeling (e.g., relating to maintenance costs, replacement costs, etc.), among other examples.

Accordingly, aspects of the present disclosure relate to metadata-assisted inventory management. In examples, image data is received that relates to telecommunications equipment. For example, image data may be received from a client application of a client device, as may be used by a customer in a customer support scenario or by a service technician during a service call. Image data includes, but is not limited to, one or more pictures, a video or a set of frames from a video, and/or a video stream. Metadata associated with the received image data is generated and associated with the received image data, thereby generating enriched image data. The enriched image data is analyzed using an equipment classification decision engine to generate one or more equipment classifications for telecommunications equipment therein. Thus, the received image data is processed in combination with associated metadata, rather than processing only the image data to generate an equipment classification. As a result of processing the image data in combination with the metadata, processing accuracy may be improved. For example, the set of possible classifications may be reduced according to the metadata (e.g., as a result of known services and/or equipment associated with a customer) or a machine learning model that is better suited for recognizing a certain type of telecommunication equipment (e.g., according to provided functionality, vendor, model, etc.) may be selected to process the image data. The equipment classification may be stored as part of the enriched image data or otherwise associated with the enriched image data, thereby further enriching the image data with processing performed by the equipment classification decision engine.

Example metadata used to enrich image data according to aspects described herein includes, but is not limited to, exchangeable image file format (EXIF) data (e.g., a timestamp, a geographic location, etc.), an identifier or other information from a smart tag associated with telecommunications equipment, customer information (e.g., an account number, an email address, a phone number, questions and associated answers received from a customer, one or more inventory records, etc.), current event data (e.g., relating to weather conditions and natural disasters, construction events, news reports, police reports, data from dark web monitoring sites to identify activities of bad actors, etc.), and/or information from a planned maintenance database, trouble tickets comprising customer feedback, or transcribed support calls. In examples, metadata is received in combination with image data or is accessed from a data source, among other examples.

As another example, metadata may comprise log data associated with the telecommunications equipment. In such examples, log data (e.g., as may be generated server-side by the service provider and/or by telecommunications equipment, among other examples) may be processed to determine whether there are any relevant log entries (e.g., according to associated timestamps, according to an operational state of telecommunications equipment, etc.). While example data sources are described herein, it will be appreciated that any of a variety of other sources may be accessed to generate enriched image data according to aspects of the present disclosure.

In examples, an inventory record comprises information associated with the telecommunications equipment, including, but not limited to, device location, a make, a model, a device status (e.g., an online status, an offline status, a warning status, an error status, etc.), and/or device configuration information (e.g., other equipment with which the device is connected and/or communicates, authentication credentials, configured capabilities, etc.). In examples, a customer may be associated with multiple inventories, where each inventory is associated with a different location for the customer. Example questions include, but are not limited to, an estimated installation date of the equipment, visible markings associated with the equipment (e.g., a model number, a manufacturer name, handwritten notes on the equipment or associated wiring, etc.), and/or location information (e.g., a building floor, a room or building number, etc.).

As used herein, “telecommunications equipment” refers to any of a variety of devices used to provide a service to a customer and may be used interchangeably with a telecommunications device. Example telecommunications equipment includes, but is not limited to, a modem, a software defined wide area network (SD-WAN) gateway, a firewall, a router, a switch, an access point, or a unified customer premises equipment (uCPE) device. As another example, telecommunications equipment may comprise cabling, such as one or more Ethernet cables or fiber optic cables. Thus, it will be appreciated that telecommunications equipment need not be restricted to devices, and may further comprise cabling or other peripheral hardware. In examples, telecommunications equipment may be owned by the service provider, leased from the service provider by the customer, owned by the customer, or any combination thereof

In examples, other decision engines are used to process the enriched image data and generate any of a variety of decision engine determinations, either in addition to or as an alternative to the equipment classification decision engine. Multiple decision engines may process enriched image data contemporaneously. In some instances, a hierarchy of decision engines may be used, where decision engine determinations of an initial decision engine are used as inputs into a subsequent decision engine. Such a hierarchy may be conditional, such that a subsequent decision engine is determined based on processing performed by the initial decision engine. Further, a decision engine may update metadata of the enriched image data. In some instances, an indication is provided to a decision engine (e.g., from another decision engine, after generating enriched image data, etc.), which causes the decision engine to process the enriched image data as described herein. In other instances, a decision engine listens for indications on a message bus or a chat channel (e.g., KAFKA topics, SLACK channels, etc.), among other communication techniques. Returning to the above equipment classification decision engine, the enriched image data and associated equipment classification may be further processed by a subsequent decision engine to generate additional determinations and to perform additional operations.

For example, a cost modeling decision engine may process the enriched image data (e.g., equipment classifications therein generated by an equipment classification decision engine) to evaluate a cost associated with the telecommunications equipment. Example cost evaluations include, but are not limited to, evaluating whether different telecommunications equipment would be more cost effective (e.g., based on power consumption, processing requirements, estimated or historical equipment lifetime, etc.), evaluating predicted or scheduled maintenance costs as compared to a replacement cost, or determining whether a service agreement to maintain the equipment is too expensive, among other examples. Such an evaluation may be performed according to a set of cost rules, where one or more determined costs are evaluated according to the set of cost rules and one or more actions are automatically performed based on the evaluation. For example, if it is determined that different telecommunications equipment is better-suited than the existing telecommunications equipment (e.g., it has a lower operations cost, a lower maintenance cost, or has processing capacity that more closely matches the utilization of existing telecommunications equipment), robotic process automation (RPA) may be used to automatically generate a request to order the different equipment and schedule a service technician to replace the existing telecommunications equipment accordingly. It will be appreciated that any of a variety of other actions may be taken according to cost determinations generated by a cost modeling decision engine.

As another example, a service evaluation decision engine may process the enriched image data to determine whether telecommunications equipment and/or an associated service are performing as expected. For example, a mean time between failure (MTBF) for telecommunications equipment may be evaluated as compared to information in the enriched image data to determine whether the device is performing according to its specifications. As another example, an SLA may be evaluated as compared to the enriched image data to determine whether a service associated with the telecommunications equipment meets the requirements or obligations set forth by the SLA. For example, the SLA may be between a vendor and the service provider or between the service provider and the customer, among other examples. An MTBF or SLA may be evaluated in relation to the enriched image data according to a set of service rules, where a service rule specifies a performance characteristic and a range or threshold for the performance characteristic that indicates the performance characteristic is in compliance with the service rule (and, by extension, the MTBF or SLA). In examples, a service rule is associated with the customer or a service provided by the service provider. A service rule may be automatically generated according to an agreed-upon service between the service provider and the customer or may be determined according to a contract between multiple parties.

In some instances, an event correlation engine evaluates indications from one or more decision engines to identify conditions associated with such indications. For example, if an equipment classification decision engine determines an operational state that is not normal, a cost modeling decision engine identifies a cost that fails a cost rule, or a service evaluation decision engine determines that a service rule was failed, the event correlation engine may identify log data that relates to such determinations. In examples, the event correlation engine identifies such log data from enriched image data and/or may identify the log data from another source and incorporate the log data into the enriched image data accordingly. The log data identified or incorporated by the event correlation engine may be tagged, highlighted, or otherwise associated with the decision engine determination, such that it is available for further evaluation (e.g., by a computing device, by a user such as a system administrator or other personnel). Thus, the event correlation engine generates additional information and gathers corroborating evidence that relates to processing performed by a decision engine, thereby providing insight into telecommunications equipment and associated services (and, in some instances, automatic issue resolution) that may not otherwise be available using other network monitoring techniques like Simple Network Management Protocol (SNMP) or syslog data aggregation.

A decision engine may use any of a variety of machine learning, statistical, and/or rule-based techniques to process enriched image data. Example neural networks that may be used to generate the machine learning models described herein include, but are not limited to, a convolutional neural network, a recurrent neural network, or a deep neural network. In examples, the machine learning model is trained (at least initially) using image data associated with devices offered by the service provider. In examples, the initial training data further comprises metadata associated with the image data, such as customer information associated with telecommunications equipment in the image data. Enriched image data may be stored and subsequently used to train a new model or retrain an existing model, such that model confidence may improve with continued use. Additionally, stored data may be reprocessed at a later date, such that previous classifications may be updated using improved models. In some examples, different machine learning models are available, where each model is associated with a different type or family of devices, or a different service market (e.g., consumer versus business, region, type of service, etc.). Accordingly, a model may be selected from the set of available models according to metadata of the enriched image data. In another example, a decision engine uses multiple models, such that a classification is selected from the model with the highest confidence or other performance metric, or as part of an ensemble, among other examples.

In other examples, a decision engine uses a statistical model to process enriched image data. The statistical model may identify one or more thresholds or ranges that are indicative of normal or routine behavior (e.g., relating to resource utilization, requests per second, cache performance, time to process a request, etc.), such that metadata that exceeds such a threshold or range is classified accordingly. As an example, an observed MTBF is generated according to failure statistics associated with classified equipment within the image data. The failure statistics may be for a population of devices associated with the service provider, for example relating to a particular model, vendor, or computing functionality, among other examples. In other examples, a stated MTBF is used instead or in addition to an observed MTBF, as may be specified by a vendor of the telecommunications equipment.

As another example, a set of service rules may be used by a decision engine. The set of service rules may be associated with a customer (e.g., a customer account, telecommunications equipment of the customer, etc.) or with a service provided by the service provider. As discussed above, a service rule may specify a performance characteristic and a range or threshold for the performance characteristic. In some instances, a service rule may be automatically generated according to an agreed-upon service between the service provider and the customer or may be determined according to a contract between multiple parties, such as an SLA. A performance characteristic evaluated by the service rule may be part of the enriched image data or may otherwise be generated based at least in part on the enriched image data. For example, uptime statistics, maintenance records, log data, or other information associated with telecommunications equipment may be processed to determine whether the telecommunications equipment satisfies the service rule (and, for example, therefore satisfies the SLA or conforms to an MTBF, among other examples).

In examples, a blockchain or other distributed ledger technology may be used to generate a validation record associated with enriched image data, thereby enabling subsequent validation of the enriched image data. As an example, a validation record comprising at least a subpart of or a cryptographic hash associated with such data may be stored in a block. The validation record may further comprise a timestamp associated with when the data was received, as well as associated customer information (e.g., a username, an email address, a customer account identifier, etc.). A subsequent block may be added to the blockchain according to blockchain technology, where the subsequent block includes a cryptographic hash of the previous block, such that validation records of the previous block may be immutable. In examples where the enriched image data is updated (e.g., by a decision engine, an event correlation engine, etc.), a new validation record may be added to the blockchain, such that the new validation record supersedes the previously generated validation record. The validation record may be used to perform validation periodically or depending on a type of action or potential impact associated with an action (e.g., whether the action is likely to affect multiple customers, whether the action is estimated to have a monetary cost above a predetermined threshold, whether the action results in replacement of telecommunications equipment, etc.), among other examples. Thus, application of blockchain technology to the optical identification and metadata enrichment techniques described herein enables confirmation of the source and validity of data, thereby reducing the potential for errors and fraud, among other potential issues.

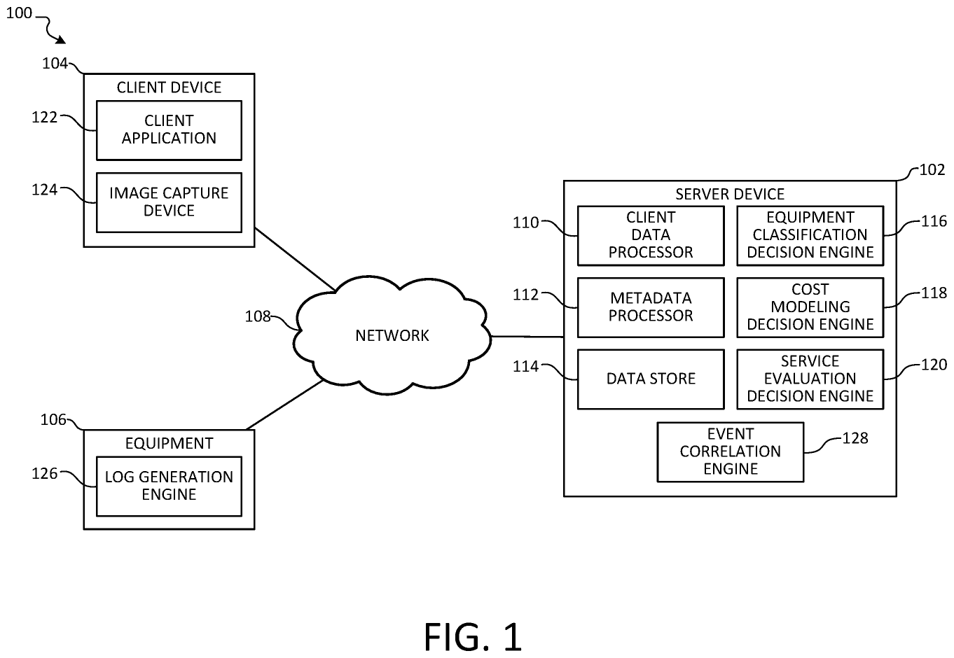

FIG. 1A illustrates an overview of an example system 100 for metadata-assisted inventory management. As illustrated, system 100 comprises server device 102, client device 104, equipment 106, and network 108. Server device 102, client device 104, and equipment 106 are illustrated as communicating through network 108. Network 108 may comprise a local area network, a wide area network, and/or the Internet, among other examples. For example, server device 102 may communicate with equipment 106 over the Internet, while client device 104 may communicate with equipment 106 over a local area network. It will be appreciated that while system 100 is described with respect to one server device 102, one client device 104, and one piece of equipment 106, any number of such elements may be used in other examples.

Client application 122 of client device 104 is used to capture image data (e.g., of equipment 106) that is processed by server device 102 according to aspects described herein. Client device 104 may be any of a variety of computing devices, including, but not limited to, a mobile computing device, a tablet computing device, a laptop computing device, or a desktop computing device. Client device 104 is illustrated as further comprising image capture device 124, which captures images and/or videos (e.g., as files, as streams, etc.), among other image data. Image capture device 124 may have a sensor that is capable of observing infrared radiation (in addition to or as an alternative to visible light). Accordingly, image capture device 124 may determine the temperature of telecommunications equipment, such that equipment temperature may be included as metadata and processed according to aspects described herein. It will be appreciated that, in some examples, multiple image capture devices are used or, in other examples, image capture device 124 is separate from client device 104. For example, an image capture device may be located on-premises and may provide a video stream of the telecommunications equipment accordingly. Such an image capture device may be located in an equipment rack or may be installed within the telecommunications equipment itself, among other examples.

According to aspects described herein, client application 122 provides instructions for a user of client device 104 to use image capture device 124 to capture image data associated with equipment 106. In examples, geolocation information is embedded in the captured image data or may be collected and/or communicated separately from the image data. It will be appreciated that client device 104 may capture any of a variety of other metadata. For example, client device 104 may communicate with a smart tag of equipment 106 (e.g., via Bluetooth, Wi-Fi, NFC, and/or RFID). The smart tag may comprise a variety of information relating to equipment 106 (e.g., a unique identifier, configuration information, etc.), which may be included as metadata associated with image data captured by image capture device 124. As another example, client application 122 may generate a display of one or more prompts comprising questions to collect other metadata from a user of client device 104. Client application 122 communicates the collected data to server device 102, which may further enrich the data and subsequently analyze the data according to aspects of the present disclosure.

While client device 104 is described as a device that is physically operated by a user, it will be appreciated that client device 104 need not be such a device and may, in other examples, be autonomously or remotely operated. For example, a terrestrial or aerial drone may be used to surveil telecommunications equipment or, as another example, may be a stationary device positioned within a server room or equipment rack.

Equipment 106 may be any of a variety of devices used to provide a service to a customer, including, but is not limited to, a modem, an SD-WAN gateway, a firewall, a router, a switch, an access point, or a uCPE device. In examples, server device 102 and equipment 106 are associated with a service provider, such as an Internet service provider and/or a voice service provider, among other examples. Equipment 106 is illustrated as comprising log generation engine 126, which generates a set of logs associated with the operation of equipment 106. Example logs include, but are not limited to, startup and/or shutdown logs, software execution logs, uptime statistics, and/or traffic statistics. Thus, it will be appreciated that logs may include key performance indicators (KPIs) associated with equipment 106. In examples, log generation engine 126 transmits at least a part of the generated logs to server device 102 (which may be stored by data store 114). For example, logs are transmitted automatically, such as after the completion of an event (e.g., after execution of a task, after startup or restarting, etc.) or periodically according to a predetermined amount of time or other schedule, among other examples. As another example, server device 102 requests one or more logs (and/or KPIs therein) from log generation engine 126, such as based on receiving image data from client device 104 or according to a predetermined schedule, among other examples.

It will be appreciated that equipment 106 may comprise any of a variety of other components. For example, equipment 106 may comprise an indicator that provides an indication as to the state of equipment 106. Example indicators include, but are not limited to, an optical indicator (e.g., a light-emitting diode (LED), a seven-segment display, or a liquid crystal display, etc.) or an auditory indicator such as a speaker, among other examples. It will be appreciated that multiple indicators may be used, each of which may be of the same type, of different types, or any combination thereof. As another example, equipment 106 may comprise a smart tag that stores a unique identifier that is associated with an entry in a data store (e.g., data store 114 of server device 102). In other examples, the smart tag may store configuration information of equipment 106, or may store any of a variety of other information. The smart tag may be active or passive, and may communicate with client device 104 as described above. Example communications include, but are not limited to, a transmission comprising an associated unique identifier or receiving an indication to provide a visual or audible indication that enables a user to physically identify equipment 106.

Server device 102 is illustrated as comprising client data processor 110, metadata processor 112, data store 114, equipment classification decision engine 116, cost modeling decision engine 118, service evaluation decision engine 120, and event correlation engine 128. Client data processor 110 communicates with client application 122 to perform the inventory management aspects described herein. For example, client data processor 110 receives an indication of image data (and, in some examples, metadata) from client application 122. In some examples, client data processor 110 provides image capture instructions to client application 122 that instruct a user of client device 104 to capture a set of images using image capture device 124 as described above. In examples, client data processor 110 generates metadata (in addition to any metadata that was received from client device 104), including, but not limited to, a timestamp indicating the time of receipt, or a cryptographic hash for the received data, among other examples. In other instances, client data processor 110 generates a validation record in a blockchain, and an identifier associated with the validation record may be included in the metadata. Client data processor 110 provides the received image data (and, in some cases, metadata) to metadata processor 112. As another example, an indication that the data has been stored in data store 114 is communicated using a message bus or a chat channel, such that metadata processor 112 receives the indication and processes the data as described herein. Thus, any of a variety of techniques may be used to provide such an indication to metadata processor 112.

Metadata processor 112 processes the image data and associated metadata to generate enriched image data, which is stored in data store 114. In examples, metadata processor 112 generates metadata from any of a variety of sources, including, but not limited to, from client device 102 (e.g., received EXIF data, a geographic location, information from a smart tag, etc.), from data store 114 (e.g., customer information, a customer inventory and one or more associated inventory records, planned maintenance information, trouble tickets, transcribed support calls, etc.), from equipment 106 (e.g., log data generated by log generation engine 126), or from a third-party data source (e.g., weather conditions, construction events, news reports, police reports, etc.). Metadata processor 112 may identify or otherwise generate such metadata based at least in part on identifying information associated with client device 104, such as a customer account and/or answers to one or more questions that were presented by client application 122 (e.g., as may be received via or generated by client data processor 110). For example, such identifying information may be received alongside the image data from client device 104 or may be determined based on a session identifier or an internet protocol (IP) address (e.g., of client device 104) associated with the indication of the image data, among other examples.

Metadata processor 112 may provide an indication that the enriched image data is available in data store 114 to equipment classification decision engine 116, cost modeling decision engine 118, service evaluation decision engine 120, and/or event correlation engine 128. In other examples, one or more of engines 116, 118, 120, and 128 listen on a message bus or subscribe to a chat channel, such that metadata processor 112 transmits the indication via the message bus or chat channel, and an engine identifies the indication and begins processing the enriched image data accordingly.

Equipment classification decision engine 116 processes the enriched image data to classify telecommunications equipment within the image data. In some examples, equipment classification decision engine 116 performs a set of preprocessing operations on the image data. Example preprocessing operations include, but are not limited to, rotating, cropping, scaling, or adjusting the brightness, contrast, and/or coloration of the received image data. As another example, a set of still frames may be generated from a video. In other instances, preprocessing the image data may comprise extracting temperature information, as may be the case when the received image data comprises image data associated with infrared radiation. It will be appreciated that any of a variety of other preprocessing operations may be performed or, in other instances, no preprocessing operations may be performed on the received image data.

Equipment classification decision engine 116 processes the enriched image data using a machine learning model. In examples, a machine learning model is selected from a set of machine learning models based at least in part on metadata of the enriched image data. For example, a machine learning model may be associated with a specific device type, service market, and/or service type, among other examples. As another example, the set of possible classifications may be filtered according to the metadata (e.g., as a result of known services and/or equipment associated with a customer). In some instances, the metadata is an input into the machine learning model in addition to the image data. In other examples, multiple machine learning models are used, where the equipment classification having the highest confidence score is used.

In examples, a confidence score is below a predetermined threshold, such that equipment classification decision engine 116 generates an indication to request additional information (e.g., via a message bus, a chat channel, etc.). The indication may comprise image capture instructions or questions to present to a user, among other examples. In another example, the confidence score is within a predetermined range that indicates the classification is likely correct. Accordingly, equipment classification decision engine 116 may update the enriched image data in data store 114 to include the classification, thereby further enriching the image data.

Equipment classification decision engine 116 may further determine an equipment configuration for one or more devices that are associated with the enriched image data. In examples, an equipment configuration is determined based on an analysis of the image data to identify one or more other devices to which the equipment is connected. In another example, the image data is evaluated to identify the physical configuration of the equipment itself (e.g., how many ports or slots are in-use, whether certain functionality is installed or otherwise enabled, etc.). In some examples, the evaluation comprises evaluating configuration information (e.g., as may have been added to the enriched image data by metadata processor 112 from an inventory record). For example, the inventory record may comprise information regarding which services and/or associated service tiers the equipment is configured to provide.

Equipment classification decision engine 116 may also determine an operational state for one or more devices associated with the enriched image data. As an example, a set of state rules may be evaluated to determine an operational state accordingly. For example, the set of state rules may be identified based on the equipment classification or based on other information in the enriched image data (e.g., a user answer to a question, an associated inventory record, etc.). A state rule may match a dark or illuminated state of one or more LEDs or any of a variety of other indicators, thereby determining the operational state of the device. In some instances, the state determination further comprises an evaluation of log data, as may have been incorporated into the enriched image data by metadata processor 112.

Equipment classification decision engine 116 may further update the enriched image data to include its decision engine determinations, such as the determined equipment configurations and/or operational states (e.g., as a standalone equipment configuration or operational state associated with the image data, as part of an inventory record for an identified device, etc.). A new validation record associated with the updated enriched image data may be generated in a blockchain, such that subsequent validation of the enriched image data indicates that the enriched image data was updated by equipment classification decision engine 116. Equipment classification decision engine 116 may also perform any of a variety of other operations, such as updating a pre-existing inventory record or generating a new inventory record based on the equipment classification. In some instances, equipment classification decision engine 116 may also add the image data to a training data store and tag the stored image data according to the generated equipment classification, thereby strengthening the ability of subsequent models to recognize such equipment. In other instances, a reference to the enriched image data may be added to the training data store, among other examples. Equipment classification decision engine 116 may provide an indication to one or more other decision engines (e.g., cost modeling decision engine 118 and service evaluation decision engine 120), which may process the enriched image data based at least in part on the generated classification.

Cost modeling decision engine 118 processes the enriched image data (e.g., before, contemporaneously with, or after equipment classification decision engine 116) to evaluate a cost associated with the telecommunications equipment. Example cost evaluations include, but are not limited to, evaluating whether different telecommunications equipment would be more cost effective (e.g., based on power consumption, processing requirements, estimated or historical equipment lifetime, etc.), evaluating predicted or scheduled maintenance costs as compared to a replacement cost, or determining whether a service agreement to maintain the equipment is too expensive, among other examples.

Cost modeling decision engine 118 evaluates metadata of the enriched image data to perform such processing, as may have been incorporated by metadata processor 112 and/or equipment classification decision engine 116. For example, cost modeling decision engine 118 may evaluate maintenance records, utilization information, weather conditions, police reports, or other information to determine whether the telecommunications equipment is a cost-effective option or whether different equipment is better-suited for the location. As another example, cost modeling decision engine 118 may determine an average maintenance cost for a type of device or a vendor based at least in part on an equipment classification indicated by the enriched image data, as may have been generated by equipment classification decision engine 116. Such evaluations may be performed based at least in part on statistical and/or machine learning models to process historical data or generate predictions, among other examples. Decision engine determinations by cost modeling decision engine 118 may be incorporated into the enriched image data accordingly and, in some examples, a new validation record associated with the updated enriched image data may be generated in a blockchain, such that subsequent validation of the enriched image data indicates that the enriched image data was updated by cost modeling decision engine 118.

In some instances, a cost modeled by cost modeling decision engine 118 is evaluated according to a set of cost rules, such that one or more actions may automatically be performed. For example, if it is determined that different telecommunications equipment is better-suited than the existing telecommunications equipment (e.g., it has a lower operations cost, a lower maintenance cost, or has processing capacity that more closely matches the utilization of existing telecommunications equipment), RPA may be used to automatically generate a request to order the different equipment and schedule a service technician to replace the existing telecommunications equipment accordingly. It will be appreciated that any of a variety of other actions may be taken according to cost determinations generated by a cost modeling decision engine. In some examples, a cost rule may be incorporated into the enriched image data by metadata processor 112 such that cost modeling decision engine 118 accesses and subsequently evaluates the cost rule and associated information from the enriched image data. In other examples, cost modeling decision engine 118 accesses cost rules from any of a variety of other sources, such as data store 114.

Service evaluation decision engine 120 processes the enriched image data to determine whether associated telecommunications equipment and/or services are performing as expected. For example, an MTBF for the telecommunications equipment may be evaluated as compared to information in the enriched image data (e.g., log data, an operational state, a maintenance cost determined by cost modeling decision engine 118, etc.) to determine whether the device is performing according to its specifications. As another example, an SLA may be evaluated as compared to the enriched image data to determine whether a service associated with the telecommunications equipment meets the requirements or obligations set forth by the SLA. For example, the SLA may be between a vendor and the service provider or between the service provider and the customer, among other examples.

In examples, service evaluation decision engine 120 evaluates an MTBF or SLA using a set of service rules, where a service rule specifies a performance characteristic and a range or threshold for the performance characteristic that indicates the performance characteristic is in compliance with the service rule (and, by extension, the MTBF or SLA). In examples, a service rule is associated with the customer or a service provided by the service provider. A service rule may be automatically generated according to an agreed-upon service between the service provider and the customer or may be determined according to a contract between multiple parties. In some examples, a service rule may be incorporated into the enriched image data by metadata processor 112 such that service evaluation decision engine 120 accesses and subsequently evaluates the service rule and associated information from the enriched image data. In other examples, service evaluation decision engine 120 accesses service rules from any of a variety of other sources, such as data store 114. Decision engine determinations by service evaluation decision engine 120 may be incorporated into the enriched image data accordingly and, in some examples, a new validation record associated with the updated enriched image data may be generated in a blockchain, such that subsequent validation of the enriched image data indicates that the enriched image data was updated by service evaluation decision engine 120.

Server device 102 is further illustrated as comprising event correlation engine 128, which evaluates indications from one or more decision engines (e.g., engines 116, 118, and/or 120) to identify conditions associated with such indications. For example, if equipment classification decision engine 116 determines an operational state that is not normal, cost modeling decision engine 118 identifies a cost that fails a cost rule, or service evaluation decision engine 120 determines a service rule failed, event correlation engine 128 may identify log data (e.g., from data store 114, as was generated by log generation engine 126 of equipment 106, etc.) that relates to such determinations. In examples, event correlation engine 128 identifies such log data from enriched image data and/or may identify the log data from another source and incorporate the log data into the enriched image data accordingly. The log data identified or incorporated by the event correlation engine may be tagged, highlighted, or otherwise associated with the decision engine determination, such that it is available for further evaluation (e.g., by a computing device, by a user such as a system administrator or other personnel). Thus, event correlation engine 128 generates additional information and gathers corroborating evidence that relates to processing performed by a decision engine, thereby providing additional insight into telecommunications equipment and/or associated services.

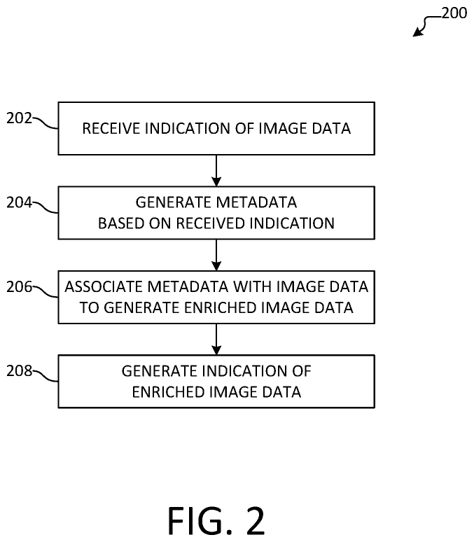

FIG. 2 illustrates an overview of an example method 200 for enriching image data from a client device using metadata. In examples, aspects of method 200 are performed by a metadata processor, such as metadata processor 112 on server device 102 discussed above with respect to FIG. 1. In an example, aspects of method 200 are performed when image data is received, for example from a client application of a client device (e.g., client application 122 of client device 104 in FIG. 1) or from an image capture device that is located in an equipment rack, among other examples.

Method 200 begins at operation 202, where an indication of image data is received. In examples, the indication comprises the image data or, in other examples, comprises a reference to image data that is stored in a data store (e.g., data store 114 of server device 102 in FIG. 1). Example image data includes, but is not limited to, one or more pictures, a video or a set of frames from a video, and/or a video stream. In some instances, the indication further comprises an indication of metadata that was received with the image data, for example as may have been generated by a client device (e.g., EXIF data, smart tag information, customer information and/or answers to questions, etc.) or by a client data processor when the image data was received from the client application (e.g., a session identifier, an IP address associated with the client device, etc.).

At operation 204, metadata is generated based on the received indication. Aspects of operation 204 may comprise determining a set of data sources from which to aggregate information, for example based on identifying information that was received at operation 202. Example identifying information includes, but is not limited to, a customer account, answers to one or more questions, a session identifier, or an IP address, among other examples. A data store (e.g., data store 114 in FIG. 1) may be accessed to determine metadata using the identifying information, such as customer information, a customer inventory and one or more associated inventory records, planned maintenance information, trouble tickets, and transcribed support calls. In other examples, metadata is accessed from telecommunications equipment (e.g., equipment 106 in FIG. 1), such as log data generated by a log generation engine. As noted in operation 202, the indication of image data may include metadata, such that the metadata indicated at operation 202 is incorporated into the generated metadata accordingly. Metadata may also be accessed from a variety of third-party data sources and may include weather conditions, construction events, news reports, and police reports, among other examples. In some instances, operation 204 comprises generating a validation record in a blockchain as described above, such that an identifier associated with the validation record may be included as part of the metadata. It will be appreciated that any of a variety of other data sources and techniques to generate metadata associated with such identifying information may be used.

Flow progresses to operation 206, where the metadata is associated with the image data to generate enriched image data. In examples, both the image data and metadata of the enriched image data are stored in the same data store. In other examples, separate image data and metadata data stores are used, where a reference between the two data stores is used to associate the image data and metadata. Accordingly, when metadata of the enriched image data is updated (e.g., by a decision engine), the metadata in the metadata data store may be changed while the image data in the image data store may remain unchanged. While example data storage techniques are described herein, it will be appreciated that any of a variety of other techniques may be used to store enriched image data.

Moving to operation 208, an indication of the enriched image data is generated. For example, a message may be broadcast via a message bus or transmitted via a chat channel. The message may comprise an indication as to where the enriched image data is stored (e.g., a unique identifier associated with the enriched image data, a uniform resource locator (URL), etc.). As described above, decision engines and/or an event correlation engine may receive the indication via the message bus or chat channel and perform subsequent processing according to aspects of the present disclosure. In other examples, operation 208 comprises providing an indication directly to one or more decision engines and/or the event correlation engine. Thus, it will be appreciated that any of a variety of techniques may be used to provide an indication of the enriched image data to another engine for further processing. Flow terminates at operation 208.

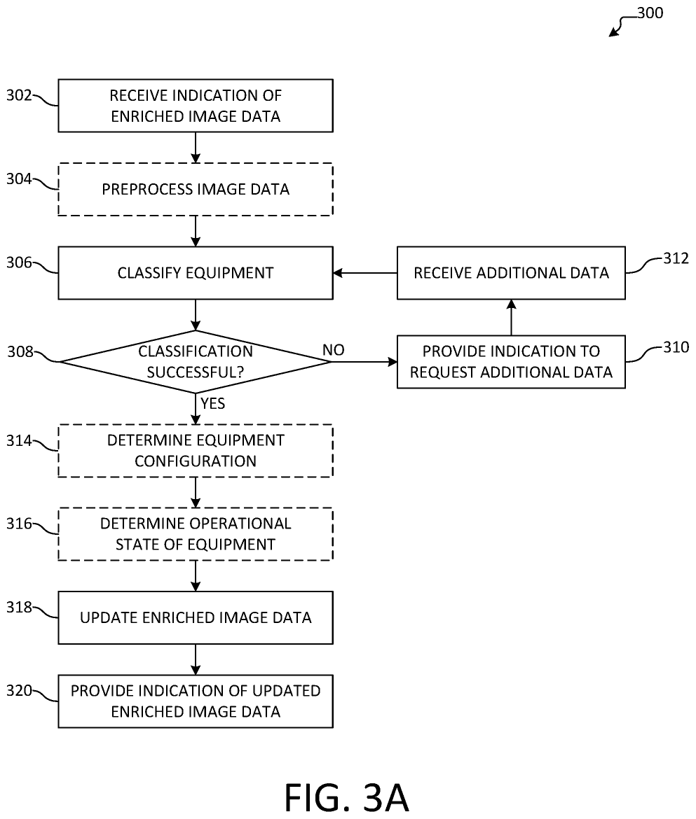

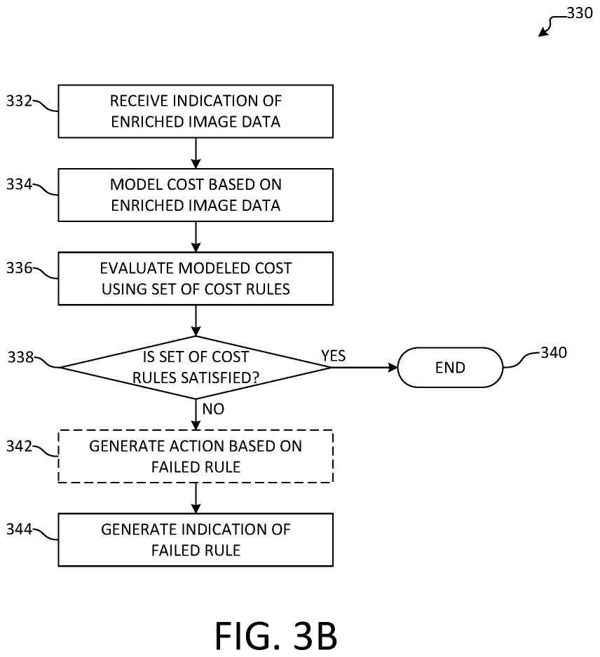

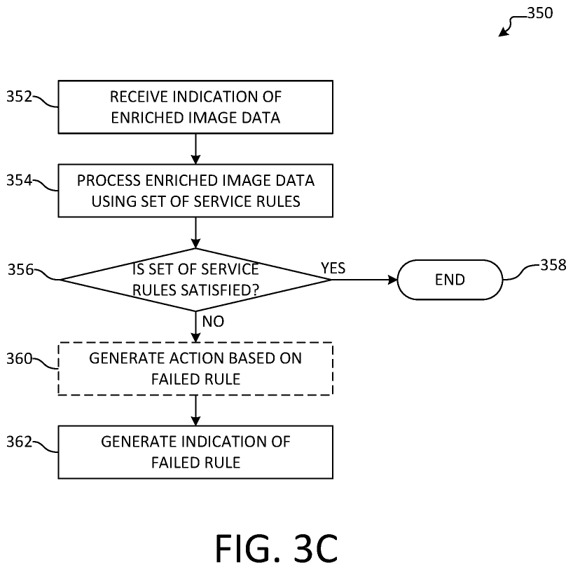

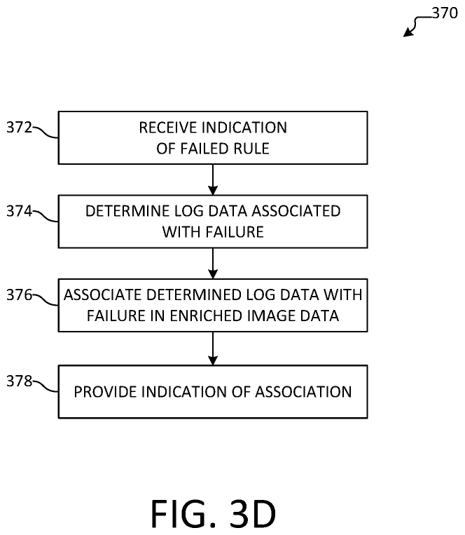

FIG. 3A illustrates an overview of an example method 300 for processing telecommunications equipment associated with enriched image data. In examples, aspects of method 300 are performed by an equipment classification decision engine, such as equipment classification decision engine 116 in FIG. 1. Method 300 begins at operation 302, where an indication of enriched image data is received. The indication may be received via a message bus or chat channel. As another example, the indication may be received from a decision engine or a metadata processor, such as metadata processor 112 in FIG. 1. The indication may have been generated as a result of performing operation 208 in method 200 of FIG. 2, as discussed above.

In some examples, flow progresses to operation 304, where image data of the enriched image data is preprocessed. For example, the image data may be rotated, cropped, scaled, or the brightness, contrast, and/or coloration may be adjusted. As another example, a set of still frames may be generated from a video of the image data or temperature information may be extracted. It will be appreciated that any of a variety of other preprocessing operations may be performed at operation 304. Operation 304 is illustrated using a dashed box to indicate that, in other instances, no preprocessing operations may be performed such that flow instead passes from operation 302 to operation 306.

At operation 306, telecommunications equipment within the image data is classified. For example, a machine learning model is used to process constituent image data. In examples, a machine learning model is selected from a set of machine learning models based at least in part on metadata of the enriched image data. A machine learning model may be associated with a specific device type, service market, and/or service type, among other examples. As another example, the set of possible classifications may be filtered according to the metadata (e.g., as a result of known services and/or equipment associated with a customer). In some instances, metadata of the enriched image data is an input into the machine learning model in addition to the image data. In other examples, multiple machine learning models are used, where the equipment classification having the highest confidence score is selected.

At determination 308, it is determined whether device classification at operation 306 was successful. In examples, the determination comprises evaluating one or more confidence scores, as may be generated by the machine learning model(s) applied at operation 306. A confidence score may be compared to a predetermined threshold and/or range. For example, if the confidence score is above a threshold or within a range, it may be determined that classification was successful. As another example, if the confidence score is below a threshold, it may be determined that classification was unsuccessful. In some examples, a range is used to determine when classification is likely successful, but the confidence score may not be high enough to definitively determine that the equipment classification was successful. In such instances, training data may be updated using the enriched image data as described above, thereby causing resulting models to better recognize such telecommunications equipment in the future. In some instances, the metadata of the enriched image data may be used to validate the equipment classification generated by the machine learning model at determination 308.

If, at determination 308, it is determined that classification was not successful, flow branches “NO” to operation 310, where an indication is provided to request additional data. In examples, the indication comprises image capture instructions, prompts, or another indication of a type of additional data that is requested. Such an indication may be provided to a client data processor and/or a client device, such as client data processor 110 or client application 122 in FIG. 1. Flow progresses to operation 312, where the additional data is received. Accordingly, flow returns to operation 306 and determination 308, where the additional data is used to classify the equipment. In examples, the additional data is analyzed separately or in combination with the enriched image data that was previously processed at operation 306. Flow eventually progresses to operation 314, which is discussed below.

If, however, it is determined at operation 308 that classification was successful, flow branches “YES” to operation 314, where equipment configuration is determined. For example, the equipment configuration is determined based on an analysis of the image data to identify one or more other devices to which the classified equipment is connected. As another example, the image data is evaluated to identify the physical configuration of the equipment itself (e.g., how many ports or slots are in-use, whether certain functionality is installed or otherwise enabled, etc.). In some examples, the evaluation comprises evaluating configuration information or other metadata of the enriched image data (e.g., as may have been generated according to aspects of method 200 in FIG. 2). For example, an inventory record (e.g., as may be part of the enriched image data, as may be accessed from a data store, etc.) may comprise information regarding which services and/or associated service tiers the equipment is configured to provide. It will be appreciated that other techniques and a variety of computer vision techniques may be used to determine an equipment configuration according to aspects described herein.

Moving to operation 316, an operational state is determined for the equipment. Operation 316 may comprise identifying one or more state rules from a data store or, in other examples, state rules may be part of the enriched image data. For example, the state rules may be identified based on the equipment classification (e.g., as was generated at operation 306) and/or based at least in part on the enriched image data, among other examples. As described herein, image data may be processed according to a state rule in order to match a dark or illuminated state of one or more LEDs or any of a variety of other indicators, thereby determining the operational state of the device.

In some instances, log data is accessed and evaluated according to a state rule. The log data may be part of the enriched image data or may be accessed from any of a variety of data sources. For example, the log data may be accessed from a data store or may be requested from a device itself. In examples where the log data is not part of the enriched image data, the log data is identified based at least in part on the equipment classification and/or the operational state of the telecommunications equipment, as well as metadata of the enriched image data. Operations 314 and 316 are illustrated using dashed boxes to indicate that, in other examples, one or both operations may be omitted.

At operation 318, the enriched image data is updated according the equipment classification, the equipment configuration, and/or the determined operational state. For example, such determinations may be added to enriched image data stored in a data store, such as data store 114 in FIG. 1. In some examples, operation 318 comprises generating a new validation record associated with the updated enriched image data in a blockchain, such that subsequent validation of the enriched image data indicates that the enriched image data was updated by aspects of method 300. As a result of updating the enriched image data, other decision engines are able to perform additional processing using the determinations that were generated at operation 306, 314, and 316.

Accordingly, at operation 320, an indication of the updated enriched image data is provided. For example, a message may be broadcast via a message bus or transmitted via a chat channel. The message may comprise an indication as to where the enriched image data is stored and, in some examples, may comprise an indication as to what was changed (e.g., added, updated, removed, etc.). As described above, decision engines and/or an event correlation engine may receive the indication via the message bus or chat channel and perform subsequent processing according to aspects of the present disclosure. In other examples, operation 320 comprises providing an indication directly to one or more decision engines and/or the event correlation engine. Thus, it will be appreciated that any of a variety of techniques may be used to provide an indication of the enriched image data to another engine for further processing. Flow terminates at operation 320.

FIG. 3B illustrates an overview of an example method 330 for performing cost modeling based on enriched image data. In examples, aspects of method 330 are performed by a cost modeling decision engine, such as cost modeling decision engine 118 in FIG. 1. Method 330 begins at operation 332, where an indication of enriched image data is received. The indication may be received via a message bus or chat channel. As another example, the indication may be received from a decision engine or a metadata processor, such as metadata processor 112 in FIG. 1. The indication may have been generated as a result of performing operation 208 in method 200 of FIG. 2 or operation 320 of method 300 in FIG. 3A, as discussed above.

At operation 334, a cost is modeled based on the enriched image data. For example, maintenance records, utilization information, weather conditions, police reports, or other information may be evaluated to determine whether telecommunications equipment associated with the enriched image data is a cost-effective option or whether different equipment is better-suited. Such information may have been incorporated into the enriched image data by a metadata processor, such as metadata processor 112 in FIG. 1. As another example, an average maintenance cost may be determined for a type of device or a vendor based at least in part on an equipment classification indicated by the enriched image data (e.g., as may have been generated by an equipment classification decision engine, such as equipment classification engine 116 in FIG. 1 performing aspects of method 300 in FIG. 3A). Such evaluations may be performed based at least in part on statistical and/or machine learning models to process historical data or generate predictions, among other examples.

Example cost evaluations that may be performed at operation 334 include, but are not limited to, evaluating whether different telecommunications equipment would be more cost effective (e.g., based on power consumption, processing requirements, estimated or historical equipment lifetime, etc.), evaluating predicted or scheduled maintenance costs as compared to a replacement cost, or determining whether a service agreement to maintain the equipment is too expensive, among other examples.

Flow progresses to operation 336, where a modeled cost from operation 334 is evaluated using a set of cost rules. In some examples, a cost rule may have been incorporated into the enriched image data by a metadata processor (e.g., metadata processor 112 in FIG. 1), such that the set of cost rules are accessed from the enriched image data and used to evaluate the modeled cost accordingly. In other examples, the set of cost rules is accessed from any of a variety of other sources, such as a data store (e.g., data store 114 in FIG. 1). The set of cost rules may be associated with a customer account, a specific device type or vendor, or an inventory record, among other examples. In some instances, at least some cost rules in a set are hierarchical or interdependent, such that a subsequent cost rule may depend on a result from an earlier cost rule.

At determination 338, it is determined whether the set of cost rules is satisfied. The determination may comprise determining whether all cost rules that were evaluated at operation 336 were satisfied, such that the failure of any rules causes the determination to branch “NO.” In other examples, a certain amount of failed rules may be permitted, or a failure within a predetermined range or threshold may be permitted (e.g., the modeled cost exceeded a cost rule, but exceeded it by a predetermined percentage). If it is determined that the set of cost rules is satisfied, flow branches “YES” and terminates at operation 340.

If, however, it is determined at determination 338 that the set of cost rules is not satisfied, flow instead branches “NO” to operation 342, where an action is generated based on the failed cost rule. For example, if it is determined that different telecommunications equipment is better-suited than the existing telecommunications equipment (e.g., it has a lower operations cost, a lower maintenance cost, or has processing capacity that more closely matches the utilization of existing telecommunications equipment), RPA may be used to automatically generate a request to order the different equipment and schedule a service technician to replace the existing telecommunications equipment accordingly.

In some instances, a validation record in a blockchain is identified and processed at operation 342 to validate the origin(s) of the enriched image data (e.g., a client device and/or client application, a metadata processor, a decision engine, etc.). The validation record may be identified according to one or more identifiers of the enriched image data. If validation fails, the generated action may not be performed. In some instances, an alternate action is performed, such as generating an indication as to the failed validation. It will be appreciated that any of a variety of other actions may be taken according to cost determinations generated by a cost modeling decision engine. Operation 342 is illustrated using a dashed box to indicate that, in other examples, operation 342 may be omitted and flow may pass from determination 338 to operation 344.

At operation 344, an indication of the failed rule is generated. For example, a message may be broadcast via a message bus or transmitted via a chat channel. The message may comprise an indication of what rule failed, why the rule failed, and/or information from the enriched image data associated with the failure determination. As described above, decision engines and/or an event correlation engine may receive the indication via the message bus or chat channel and perform subsequent processing according to aspects of the present disclosure. In other examples, operation 344 comprises updating the enriched image data to incorporate the failure determination and associated information and providing an indication associated with the updated enriched image data according to aspects described herein. A new validation record associated with the updated enriched image data may be generated in a blockchain, such that subsequent validation of the enriched image data indicates that the enriched image data was updated by aspects of method 330. In another instance, an indication is provided directly to one or more decision engines and/or the event correlation engine. Thus, it will be appreciated that any of a variety of techniques may be used to provide a failure indication for further processing. Flow terminates at operation 344.

FIG. 3C illustrates an overview of an example method 350 for service evaluation based on enriched image data. In examples, aspects of method 350 are performed by a service evaluation decision engine, such as service evaluation decision engine 120 in FIG. 1. Method 350 begins at operation 352, where an indication of enriched image data is received. The indication may be received via a message bus or chat channel. As another example, the indication may be received from a decision engine or a metadata processor, such as metadata processor 112 in FIG. 1. The indication may have been generated as a result of performing operation 208 in method 200 of FIG. 2, operation 320 of method 300 in FIG. 3A, or operation 344 of method 330 in FIG. 3B, as discussed above.

Flow progresses to operation 354, where telecommunications equipment associated with the enriched image data is evaluated according to a set of service rules to determine whether the telecommunications equipment and/or associated services are performing as expected. For example, an MTBF for the telecommunications equipment may be evaluated as compared to information in the enriched image data (e.g., log data, an operational state, a maintenance cost determined by a cost modeling decision engine, such as cost modeling decision engine 118 in FIG. 1, etc.) to determine whether the device is performing according to its specifications. As another example, an SLA may be evaluated as compared to the enriched image data to determine whether a service associated with the telecommunications equipment meets the requirements or obligations set forth by the SLA. For example, the SLA may be between a vendor and the service provider or between the service provider and the customer, among other examples.

In examples, operation 354 evaluates an MTBF or SLA using a set of service rules, where a service rule specifies a performance characteristic and a range or threshold for the performance characteristic that indicates the performance characteristic is in compliance with the service rule (and, by extension, the MTBF or SLA). In examples, a service rule is associated with the customer or a service provided by the service provider. A service rule may be automatically generated according to an agreed-upon service between the service provider and the customer or may be determined according to a contract between multiple parties. In some examples, a service rule may be incorporated into the enriched image data by a metadata processor (e.g., metadata processor 112 in FIG. 1), such that it is accessed from the enriched image data accordingly and subsequently used at operation 354. In other examples, service rules are accessed from any of a variety of other sources, such as a data store (e.g., data store 114 in FIG. 1). In some instances, at least some service rules in a set are hierarchical or interdependent, such that a subsequent service rule may depend on a result from an earlier service rule.

At determination 356, it is determined whether the set of service rules is satisfied. The determination may comprise determining whether all service rules that were evaluated at operation 354 were satisfied, such that the failure of any rules causes the determination to branch “NO.” In other examples, a certain amount of failed rules may be permitted, or a failure within a predetermined range or threshold may be permitted (e.g., the modeled cost exceeded a cost rule, but exceeded it by a predetermined percentage). If it is determined that the set of service rules is satisfied, flow branches “YES” and terminates at operation 358.

If, however, it is determined at determination 356 that the set of service rules is not satisfied, flow instead branches “NO” to operation 360, where an action is generated based on the failed service rule. For example, if it is determined that different or replacement telecommunications equipment would resolve the failed rule, RPA may be used to automatically generate a request to order the different equipment and schedule a service technician to replace the existing telecommunications equipment accordingly. As another example, the telecommunications equipment and/or other associated device may be reconfigured.

In some instances, a validation record in a blockchain is identified and processed at operation 360 to validate the origin(s) of the enriched image data (e.g., a client device and/or client application, a metadata processor, a decision engine, etc.). The validation record may be identified according to one or more identifiers of the enriched image data. If validation fails, the generated action may not be performed. In some instances, an alternate action is performed, such as generating an indication as to the failed validation. It will be appreciated that any of a variety of other actions may be taken according to such service evaluation techniques. Operation 360 is illustrated using a dashed box to indicate that, in other examples, operation 360 may be omitted and flow may pass from determination 356 to operation 362.

At operation 362, an indication of the failed rule is generated. For example, a message may be broadcast via a message bus or transmitted via a chat channel. The message may comprise an indication of what rule failed, why the rule failed, and/or information from the enriched image data associated with the failure determination. As described above, decision engines and/or an event correlation engine may receive the indication via the message bus or chat channel and perform subsequent processing according to aspects of the present disclosure. In other examples, operation 362 comprises updating the enriched image data to incorporate the failure determination and associated information and providing an indication associated with the updated enriched image data according to aspects described herein. A new validation record associated with the updated enriched image data may be generated in a blockchain, such that subsequent validation of the enriched image data indicates that the enriched image data was updated by aspects of method 350. In another instance, an indication is provided directly to one or more decision engines and/or the event correlation engine. Thus, it will be appreciated that any of a variety of techniques may be used to provide a failure indication for further processing. Flow terminates at operation 362.

FIG. 3D illustrates an overview of an example method 370 for correlating network events associated with an identified decision engine determination. In examples, aspects of method 370 are performed by an event correlation engine, such as event correlation engine 128 in FIG. 1. Method 370 begins at operation 372, where an indication of a failed rule is received. The indication may be received via a message bus or chat channel. As another example, the indication may be received from a decision engine, such as decision engines 116, 118, or 120 in FIG. 1. The indication may have been generated as a result of performing operation 320 of method 300 in FIG. 3A, operation 344 of method 330 in FIG. 3B, or operation 362 of method 350 in FIG. 3C as discussed above. In examples, the indication comprises an indication of a rule that was not satisfied (e.g., a cost rule, a service rule, etc.) and/or information associated with the failure (e.g., a modeled cost, a performance characteristic of the telecommunications equipment, etc.). In some instances, the indication comprises enriched image data or a reference thereto. While method 370 is described in an example where the indication is one of a failed rule, it will be appreciated that similar techniques are applicable to other failures or anomalies, such as an abnormal operational state, as may be identified by operation 316 of method 300 in FIG. 3A.

At operation 374, log data associated with the failure is identified from enriched image data and/or from another source, such as a data store (e.g., data store 114 in FIG. 1, log generation engine 126, etc.). If the log data is identified from another source, the log data may be incorporated into the enriched image data accordingly. As an example, the failure indication received at operation 372 may be used to identify log data for associated telecommunications equipment, as may be generated by a log generation engine and/or stored by a data store.

Moving to operation 376, the determined log data may be tagged, highlighted, or otherwise associated with the failure determination, such that it is available for further evaluation (e.g., by a computing device, by a user such as a system administrator or other personnel). In some instances, the association is stored as part of the enriched image data or may be stored in a separate data store, among other examples. In examples where the enriched image data is updated, a new validation record associated with the updated enriched image data may be generated in a blockchain, such that subsequent validation of the enriched image data indicates that the enriched image data was updated by aspects of method 370.

Flow progresses to operation 378, where an indication of the association is provided, for example via a message bus or chat channel according to aspects described herein. The indication may comprise a reference to the enriched image data or the data store in which the association was generated. As another example, the indication comprises the failure determination and determined log data, such that other sources need not be accessed when processing the indication. Flow terminates at operation 378.

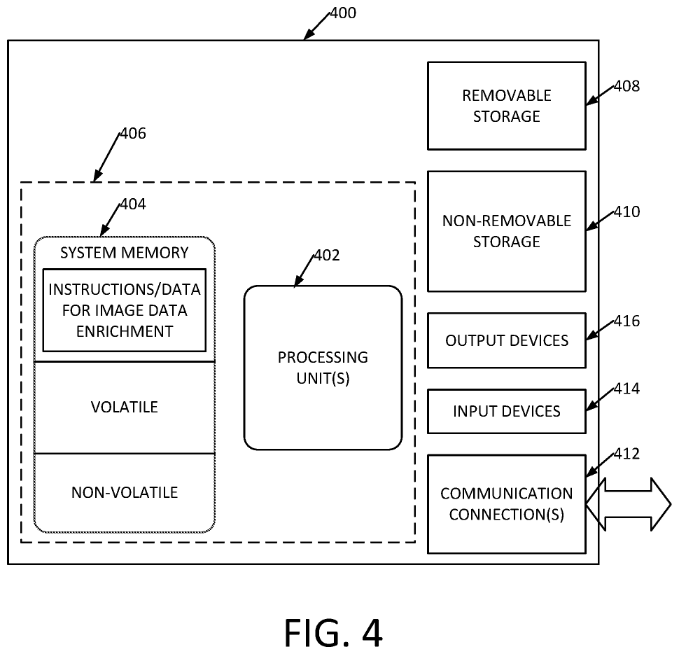

FIG. 4 illustrates an example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically may include at least one processing unit 402 and memory 404. Depending on the exact configuration and type of computing device, memory 404 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as a keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 may include at least some form of computer readable media. The computer readable media may be any available media that can be accessed by processing unit 402 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 404. While executing on the processing unit 402, program modules (e.g., applications, Input/Output (I/O) management, and other utilities) may perform processes including, but not limited to, one or more of the stages of the operational methods described herein such as the methods illustrated in FIGS. 2 and 3A-D, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 400 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

This disclosure described some aspects of the present technology with reference to the accompanying drawings, in which only some of the possible embodiments were shown. Other aspects may, however, be embodied in many different forms and should not be construed as limited to the embodiments set forth herein. Rather, these aspects were provided so that this disclosure was thorough and complete and fully conveyed the scope of the possible embodiments to those skilled in the art.

Although specific aspects were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
at least one processor; and
memory, operatively connected to the at least one processor and storing instructions that, when executed by the at least one processor, cause the system to perform a set of operations, the set of operations comprising:
receiving, from a client device, image data associated with telecommunications equipment;
generating metadata associated with the telecommunications equipment;
storing the image data and the metadata as enriched image data;
processing, using a decision engine, the enriched image data to generate a decision engine determination;
associating the decision engine determination with the enriched image data to generate updated enriched image data; and
providing an indication of the updated enriched image data to another decision engine.

2. The system of claim 1, wherein the metadata comprises at least one of:
information from a smart tag of the telecommunications equipment;
log data associated with the telecommunications equipment;
customer information;
current event data;
exchangeable image file format data;
information from a planned maintenance database;
information from a trouble ticket; or
information from a transcribed support call.

3. The system of claim 1, wherein the set of operations further comprises:
generating, for the enriched image data, a validation record in a blockchain.

4. The system of claim 3, wherein processing the enriched image data using the decision engine further comprises:
identifying, based on the enriched image data, the validation record in the block chain;
validating, using the validation record, the enriched image data; and
based on determining the enriched image data is valid, performing, by the decision engine, an action based on the decision engine determination.

5. The system of claim 1, wherein:
the decision engine is an equipment classification decision engine; and
the decision engine determination is an equipment classification for the telecommunications equipment generated using a machine learning model selected based at least in part on the metadata.

6. The system of claim 1, wherein:
identifying information is received from the client device with the image data; and
the metadata associated with the telecommunications equipment is generated based at least in part on the identifying information.

7. The system of claim 1, wherein the enriched image data is processed to generate a decision engine determination in response to receiving an indication that the enriched image data was stored.

8. A method for processing enriched image data by a decision engine, the method comprising:
receiving an indication of enriched image data, wherein the enriched image data comprises image data associated with telecommunications equipment and metadata associated with the telecommunications equipment;
processing the enriched image data to generate a decision engine determination;
associating the decision engine determination with the enriched image data to generate updated enriched image data; and
generating an electronic communication indicating the updated enriched image data.

9. The method of claim 8, wherein the enriched image data is processed using at least one of a machine learning model, a statistical model, or a rule to generate the decision engine determination.

10. The method of claim 8, further comprising:
in response to the received indication, validating a first validation record in a block chain; and
generating, for the updated enriched image data, a second validation record in the blockchain.

11. The method of claim 8, wherein the electronic communication is transmitted using a message bus or a chat channel.

12. The method of claim 8, wherein:
the decision engine determination is a first decision engine determination; and
the metadata associated with the telecommunications equipment comprises a second decision engine determination from another decision engine.

13. The method of claim 8, wherein the metadata associated with the telecommunications equipment comprises at least one of:
information from a smart tag of the telecommunications equipment;
log data associated with the telecommunications equipment;
customer information;
current event data;
exchangeable image file format data;
information from a planned maintenance database;
information from a trouble ticket; or
information from a transcribed support call.

14. A method for enriching image data, the method comprising:
receiving, from a client device, image data associated with telecommunications equipment;
generating metadata associated with the telecommunications equipment;
storing the image data and the metadata as enriched image data;
processing, using a decision engine, the enriched image data to generate a decision engine determination;
associating the decision engine determination with the enriched image data to generate updated enriched image data; and
providing an indication of the updated enriched image data to another decision engine.

15. The method of claim 14, wherein the metadata comprises at least one of:
information from a smart tag of the telecommunications equipment;
log data associated with the telecommunications equipment;
customer information;
current event data;
exchangeable image file format data;
information from a planned maintenance database;
information from a trouble ticket; or
information from a transcribed support call.

16. The method of claim 14, further comprising:
generating, for the enriched image data, a validation record in a blockchain.

17. The method of claim 16, wherein processing the enriched image data using the decision engine further comprises:
identifying, based on the enriched image data, the validation record in the block chain;
validating, using the validation record, the enriched image data; and
based on determining the enriched image data is valid, performing, by the decision engine, an action based on the decision engine determination.

18. The method of claim 14, wherein:
the decision engine is an equipment classification decision engine; and
the decision engine determination is an equipment classification for the telecommunications equipment generated using a machine learning model selected based at least in part on the metadata.

19. The method of claim 14, wherein:
identifying information is received from the client device with the image data; and
the metadata associated with the telecommunications equipment is generated based at least in part on the identifying information.

20. The method of claim 14, wherein the enriched image data is processed to generate a decision engine determination in response to receiving an indication that the enriched image data was stored.
